(19) United States
(12) Patent Application Publication
(10) Pub. No.: US 2026/0161879 A1
(43) Pub. Date: Jun. 11, 2026

(54) MACHINE LEARNING BASED MERGE FOR DOCUMENT FORMATS

(71) Applicant: SAP SE, Walldorf (DE)

(72) Inventors: Richard Kuba, Brno (CZ); Tomas Rysavy, Miroslav (CZ); Marek Halas, Velka Luka (SK); Martin Langer, Lanskroun (CZ); Tomas Zavadil, Brno (CZ); Michal Pandoscak, Poruba pod Vihorlatom (SK)

(21) Appl. No.: 18/977,131

(22) Filed: Dec. 11, 2024

(51) Int. Cl. G06F 40/117; G06F 40/279; G06F 40/40

(52) U.S. Cl. CPC G06F 40/117; G06F 40/279; G06F 40/40

(57) ABSTRACT

Described herein are systems and method for using machine learning to merge document formats. In some embodiments, a computer-implemented method includes comparing, using a first machine learning model, a first document format and a second document format, the first machine learning model matching a first set of nodes in the first document format to a second set of nodes in the second document format; in response to a third set of nodes of the first document format detected as not having a match in the second plurality of nodes of the second document format, providing, to a second machine learning model, the second document format and the third set of nodes of the first document format; and receiving, from the second machine learning model, a fourth set of nodes matching the third set of nodes of the first document format. Related systems, methods, and articles of manufacture are also disclosed.

### TECHNICAL FIELD

The present disclosure generally relates to machine learning.

### BACKGROUND

Document processing may involve dozens if not hundreds of different formats. These formats may include customized formats, which may be extensions of other formats including standardized formats. Handling the different formats and their changes is important as the exchange of improperly formatted documents may prevent two systems from properly exchanging information.

### SUMMARY

In some embodiments, there is provided a computer-implemented method that includes receiving an indication of a change for a first document type, the change from a first document format to a second document format; retrieving the first document format comprising a first plurality of nodes in a first hierarchal structure and the second document format comprising a second plurality of nodes in a second hierarchal structure; detecting differences in the first document format and the second document format, wherein the detecting the differences includes comparing, using a first machine learning model, the first document format and the second document format, the first machine learning model matching a first set of nodes in the first document format to a second set of nodes in the second document format, in response to a third set of nodes of the first document format detected as not having a match in the second plurality of nodes of the second document format, providing, to a second machine learning model, the second document format and the third set of nodes of the first document format, receiving, from the second machine learning model, a fourth set of nodes matching the third set of nodes of the first document format; performing a first mapping between the first set of nodes and the second set of nodes and further performing a second mapping between the third set of nodes and the fourth set of nodes; converting, based on the first mapping and the second mapping, the first document format and the second document format; and accessing the converted second document format to enable formatting a document in the converted second document format.

In some variations, one or more features disclosed herein including the following features can optionally be included in any feasible combination. The first document type may include a payment document. The first document format may include a first extensible markup language document including the first plurality of nodes in the first hierarchal structure, and wherein the second document format may include a second extensible markup language document comprising the second plurality of nodes in the second hierarchal structure. The first machine learning model may compare the first document format and the second document format by matching a first set of tags for the first set of nodes to a second set of tags for the second set of nodes, wherein the matching is based on a same text string between tags. The third set of nodes may correspond to a third set of tags in the first document format, wherein the third set of tags do not have a corresponding match based on a same text string between tags. The second machine learning model may include a large language model, wherein the large language model matches the fourth set of nodes matching to the third set of nodes of the first document format using a similarity in text strings between tags.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts an example of a system for machine learning based format merge, according to some implementations of the current subject matter;

FIG. 2 depicts an example of a process for machine learning based format merge, according to some implementations of the current subject matter;

FIG. 3A depicts an example of a user interface triggering a format merge, according to some implementations of the current subject matter;

FIG. 3B depicts an example two document formats, according to some implementations of the current subject matter;

FIG. 4 depicts another example of a system, according to some implementations of the current subject matter; and

FIG. 5 depicts another example of a system, according to some implementations of the current subject matter.

### DETAILED DESCRIPTION

In some systems, such as an enterprise resource planning (ERP) system, documents may be stored in a database instance in a certain format. The phrase “enterprise resource planning system” refers to a system used by for example an organization to perform a variety of automated processes for finance (e.g., accounting, financials, and reporting), human resources (e.g., payroll, attendance, and hours worked), manufacturing (e.g., production and inventory), supply chain (e.g., procurement, risk management, and compliance), and/or the like.

In the case of finance functions of the ERP system for example, a document, such as a payment document, may be configured in a variety of formats. These formats may be customized to a specific payee, a bank, and/or comply with certain standards. The formats define, for the document such as the payment document, the structure and/or meaning of data in the document (e.g., an electronic file) to facilitate communication between for example a first client device and a second client device.

In the case of payment formats, the communication may be between a company and a financial institution, such as a bank. The payment format may include (or, e.g., define) an indication of which invoice(s) is/are to be paid with the payment document, an identity of a payee (e.g., whom the payment should be made to), a payment amount, currency to be used, a number (e.g., an identity) of the invoice being paid, and/or other information.

There are, as noted, one or more standards that may be used to define a document format, such as the payment format. For example, a standards-based format, such as ISO 20022, may undergo version changes from time to time. Despite the ISO standard, many financial institutions use their own “customized” payment format (and, the customized payment format may be an extension or customization of a standards-based format). Any changes to the “customized” payment format (which may be caused by for example version updates or other types of changes) may be resource intensive (e.g., at a company associated with the ERP system) since making the change may propagate to a plurality of payment formats used by a plurality of financial institutions.

When a change to the standards-based format (upon on which the financial institution's payment format is based) occurs, the change may cause incompatibility in the payment format between for example the end-user's ERP system and the financial institution's system. In this example, the financial institution may require the end-user's ERP system to upgrade to the new version of the ISO format, so the changes may need to be performed manually to update the changes to conform to the structure of the new version of the ISO format, for example. This manual process may be, as noted, resource intensive with respect to time, processor usage, and prone to error.

In some embodiments, there is provided a process for converting a first document format to a second document format using a first machine learning model and a second machine learning model. In some embodiments, the first machine learning model performs a comparison between the two formats, such that the same nodes in the two different document formats are mapped to link the same nodes. For any nodes in the first document format not mapped to a corresponding node in the second document format based on the first ML model, a second ML model may be used to find a mapping, wherein the second ML model matches semantically similar (or equivalent) nodes that could not be matched or identified by the first ML model.

In some embodiments, the first ML model is an ML model configured to find or identify matching nodes using for example the same text string of the XML (extensible markup language) tags in the first document format and the second document format. In some embodiments, the second ML model comprises a large language model (LLM), although other types of ML models may be used as well. For example, the second ML model, such as the LLM, may be used to find or identify semantically similar (or equivalent) nodes (e.g., based on XML tags) that are similar, for example, an XML tag such as “LtrInvoiceID” for a first node matching an XML tag such as “MstInvID” for a second node. In this example, the first ML model cannot associate the two document nodes as they are not the same, but the second ML model is used to determine that the two nodes are similar or equivalent (e.g., the text strings are withing a threshold amount of similarity).

Before providing additional description regarding the process for converting, such as merging the first document format to the second document format using a first machine learning model and a second machine learning model, the following provides an example of a system environment in which the process may be practiced.

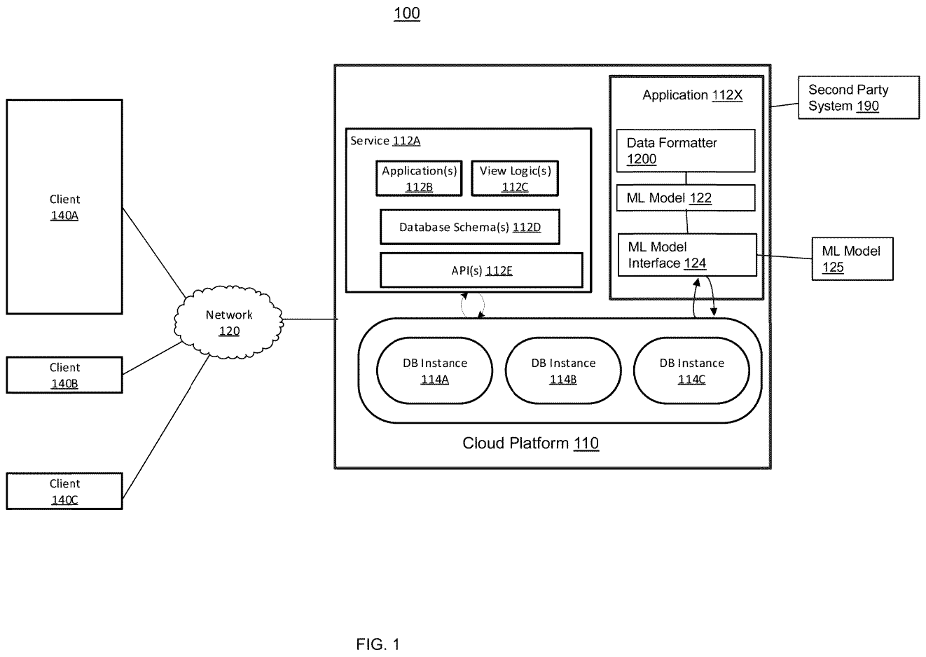

FIG. 1 depicts an example of a system 100 for converting between document formats consistent with some implementations of the current subject matter.

The system 100 may include a cloud platform 110 that provides resources that can be shared among a plurality of tenants. For example, the cloud platform 110 may be configured to provide a variety of services including, for example, software-as-a-service (SaaS), platform-as-a-service (PaaS), infrastructure as a service (IaaS), database as a service (DaaS), and/or the like, and these services can be accessed, via network 120, by one or more tenants of the cloud platform 110. In the example of FIG. 1, the cloud platform 110 may comprise at least a portion of an ERP system.

The network 120 may be any wired and/or wireless network including, for example, a public land mobile network (PLMN), a wide area network (WAN), a local area network (LAN), a virtual local area network (VLAN), the Internet, link(s), a bus, and/or the like.

In the example of FIG. 1, the system 100 may include at least one tenant, such as a first tenant (e.g., at the first client 140A), a second tenant (e.g., at the second client 140B), and a third tenant (e.g., at the third client 140C), although cloud platform 110 may have other quantities of tenants. The clients may each comprise a user device (e.g., a computer including an application such as a browser or other type of application). The user device may be a processor-memory-based device including, for example, a smartphone, a tablet computer, a wearable apparatus, a virtual assistant, an Internet-of-Things (IoT) appliance, and/or the like. Each client may access, via network 120, at least one of the services at the cloud platform 110. In some implementations, each of the tenants represents a separate tenant at the cloud platform 110, such that a tenant's data is not shared with other tenants (absent permission from a tenant). Alternatively, each of the tenants may represent a single tenant at the cloud platform 110, such that the tenants can share a portion of the tenant's data, for example.

The cloud platform 110 may include resources, such as at least one computer (e.g., a server), data storage, and a network resources (including network equipment) that couples the computer(s) and/or storage. The resources may include services or applications as well. The cloud platform may also include other resources, such as operating systems, hypervisors, and/or other resources, to virtualize physical resources (e.g., via virtual machines), provide deployment (e.g., via containers) of applications (which provide services, for example, on the cloud platform, and other resources. In the case of a “public” cloud platform, the services may be provided on-demand to a client, or tenant, via the Internet. For example, the resources at the public cloud platform may be operated and/or owned by a cloud service provider (e.g., Amazon Web Services, Azure, SAP Service Cloud, and/or the like.), such that the physical resources at the cloud service provider can be shared by a plurality of tenants. Alternatively, or additionally, the cloud platform may be a “private” cloud platform, in which case the resources of the cloud platform may be hosted on an entity's own private servers (e.g., dedicated corporate servers operated and/or owned by the entity). Alternatively, or additionally, the cloud platform may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In the example of FIG. 1, the cloud platform 110 includes a service 112A, which is provided to the client (e.g., the first client 140A). This service 112A may be deployed via a container, which provides a package or bundle of software, libraries, configuration data to enable the cloud platform to deploy during runtime the service 112A to, for example, one or more virtual machines that provide the service at the cloud platform. In the example of FIG. 1, the service 112A is deployed during runtime, and provides at least one application such as an application 112B (which is the runtime application providing the service 112A and served to the client such as first client 140A). To illustrate further, the client (e.g., tenant at the first client 140A) may access the application 112B to view data and/or query data stored in a database instance, such as database instance 114A, database instance 114B, or database instance 114C, for example.

The service 112A may also provide view logic 112C. The view logic (also referred to as a view layer) links the application 112B to the data in the database instance 114A, such that a view of certain data in the database instances is generated for the application 112B. For example, the view logic may include, or access, a database schema 112D for database instance 114A in order to access at least a portion of at least one table at the database instance 114A (e.g., generate a view of a specific set of rows and/or columns of a database table or tables). In other words, the view logic 112C may include instructions (e.g., rules, definitions, code, script, and/or the like) that can define how to handle the access to the database instance and retrieve the desired data from the database instance. The service 112A may include the database schema 112D. The database schema 112D may be a data structure that defines how data is stored in the database instance 114A. For example, the database schema may define the database objects that are stored in the database instance 114A. The view logic 112C may provide an abstraction layer between the database layer (which include the database instances 114A-C, also referred to more simply as databases) and the application layer, such as application 112B, which in this example is a multitenant application at the cloud platform 110.

The service 112A may also include an interface 112E to the database layer, such as the database instance 114A and the like. The interface 112E may be implemented as an Open Data Protocol (OData) interface (e.g., HTTP message may be used to create a query to a resource identified via a URI), although the interface 112E may be implemented with other types of protocols including those in accordance with REST (Representational state transfer). In the example of FIG. 1, the database instance 114A may be accessed as a service at a cloud platform, which may be the same or different platform from cloud platform 110. In the case of REST compliant interfaces, the interface 112E may provide a uniform interface that decouples the client and server, is stateless (e.g., a request includes all information needed to process and respond to the request), cacheable at the client side or the server side, and the like.

The database instances 114A-C may each correspond to a runtime instance of a database management system (also referred to as a database). One or more of the database instances may be implemented as an in-memory database (in which most, if not all, the data, such as transactional data, is stored in main memory). In the example of FIG. 1, the database instances are deployed as a service, such as a DaaS, at the cloud platform 110. Although the database instances are depicted at the cloud platform 110, one or more of the database instances may be hosted on another or separate platform (e.g., on-premises) and/or another cloud platform.

The system 100 may also include an application 112X (which may be configured to include view logic, database schemas, APIs, and/or the like as noted above with respect to application 112B). In the example of FIG. 1, the application 112X comprises a data formatter 1200 application or service. The data formatter application may be accessed by at least one of the client devices, such as at the first client 140A, to convert a first document format to a second document format. The system 100 may also include a first ML model 122, an ML model interface 124, and a second ML model 125.

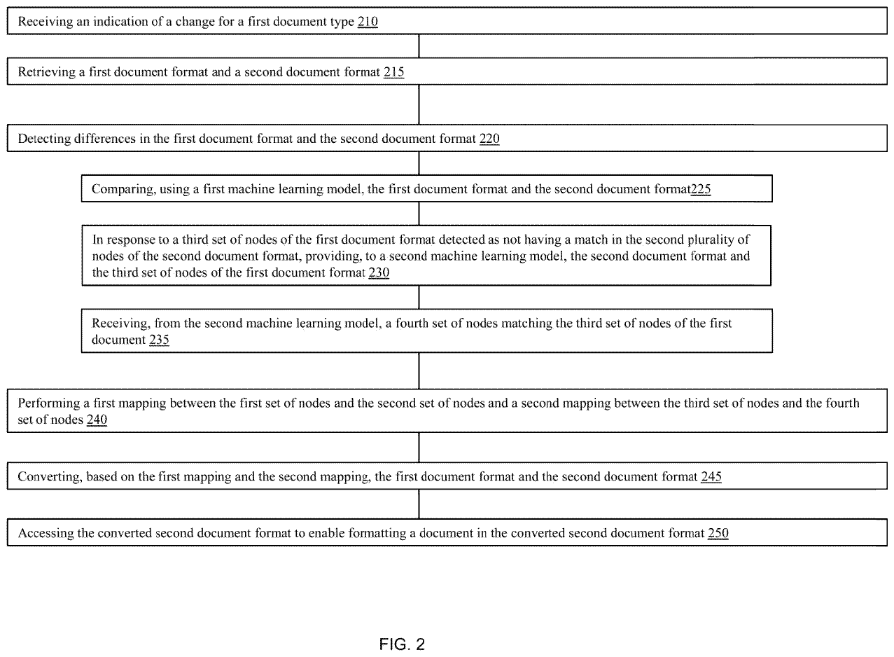

FIG. 2 depicts an example a process 200 to merge a first document format and a second document format, in accordance with some embodiments. The process 200 may be used to provide for example a computer-implemented method.

At 210, the process 200 may include receiving an indication of a change for a first document type, wherein the change is from a first document format to a second document format.

In the case of a first document type corresponding to a payment document for example, the payment document may have a source document format which was being used before a change to a target document format. Referring to FIG. 1, when there is a change in the payment format for example, the change may be received as an indication, such as a failed payment transfer between the cloud platform 110 and a second party system 190, such as a financial institution's payment processing system, although the change indication may be received or obtained in other ways.

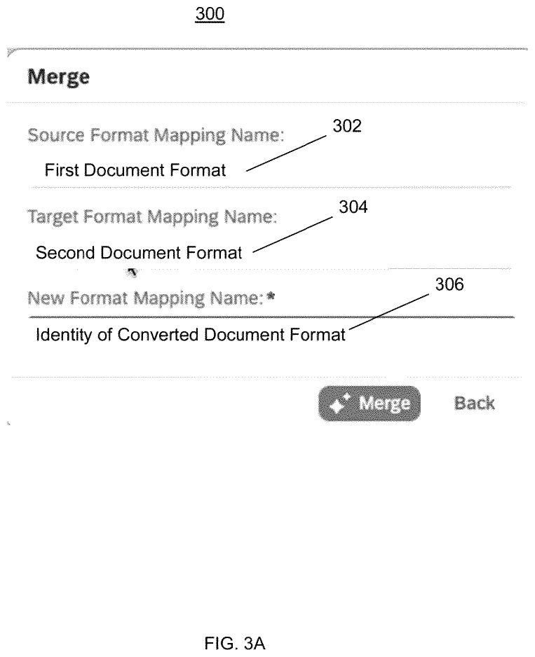

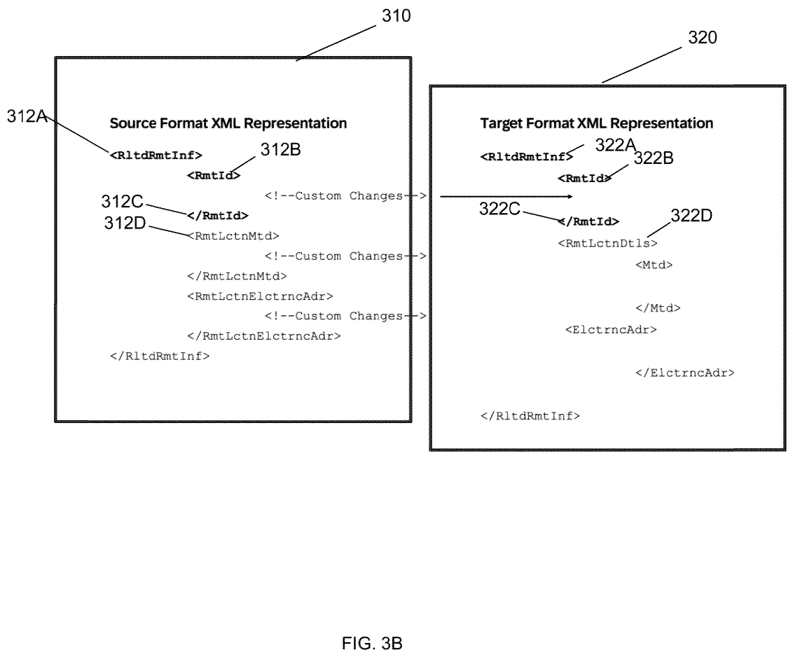

FIG. 3A depicts an example user interface 300 (which may be generated by the data formatter 1200 application). This user interface may be presented at for example first client 140A device in response to a change in formats. In this example, the document format may be of a payment document from the cloud platform 110 to the second party system 190. When the user interface 300 is presented at the first client 140A device, a first selection 302 may indicate the first document format, such as a source document format for bank A (which as noted may be a current or existing customized format used by the cloud platform 110). A second selection 304 (at the user interface 300) may indicate a second target document format, such as an update to the customized bank format or a new version of the ISO20022 standard, for example. Moreover, a third selection 306 may be used to define the identity of the converted document format which merges (e.g., converts) the source and target formats.

Referring again to FIG. 2, the process 200 may include retrieving, at 215, the first document format comprising a first plurality of nodes in a first hierarchal structure and the second document format comprising a second plurality of nodes in a second hierarchal structure. Referring to FIG. 1 for example, the data formatter 1200 may retrieve (e.g., from a persistent store such as database instance 114C) a first document format and a second document format. The first and second document formats may each comprise a plurality of nodes in a hierarchal structure. For example, the first and second document formats may be XML documents in a tree-like hierarchy including nodes.

FIG. 3B depicts an example of a first document format 310, such as a source format for bank A. In the example of FIG. 3B, the first document format 310 is an XML document including a plurality of nodes (e.g., node 312A, node 312B, node 312C, and node 312D), which are identified by tags, such as XML tags. For example, the node 312A has a tag of “RltdRmtInf”. And, the nodes are in a hierarchical structure. FIG. 3B also depicts an example of a second document format 320, such as a target document format (e.g., an updated or changed customized format for bank A). In the example of FIG. 3B, the second document format 320 is also an XML document including a plurality of nodes (e.g., node 322A, node 322B, node 322C, and node 322D, and these nodes are identified with tags, such as XML tags.

At 220, the process 200 may include detecting differences in the first document format and the second document format. For example, the first document format 310 may include one or more node that are the same (e.g., have the same text string for their tags) as one or more nodes in the second document format 320.

To detect differences in the first document format and the second document format, the process 200 may include comparing, at 225 using a first ML model 122, the first document format and the second document format, the first machine learning model matching a first set of nodes in the first document format to a second set of nodes in the second document format. For example, the first ML model 122 may compare the first document format 310 by finding a match in the second document format 320. The first ML model 122 may be trained to do a string comparison between the node names. Referring to FIG. 3B for example, the first ML model may identify a first set of nodes, such as the node 312A (“RltdRmtInf”) that matches the same text string for the tag (“RltdRmtInf”) of the node 322A at the second document format 320. Likewise, the first ML model may identify at least the node 312B and the node 322B, which matches. In this example, the first set of nodes would correspond to the node 312A and the node 312B, while the second matching set of nodes correspond to node 322A and node 322B.

At 230, the process 200 may include in response to a third set of nodes of the first document format detected as not having a match in the second plurality of nodes of the second document format, providing, to a second machine learning model, the second document format and the third set of nodes of the first document format. For example, the first ML model 122 may detect that the node 312D (with a tag text string of “RmtLctnMtd”) does not have a corresponding node with a text string tag that is the same. In this example, the node 312D would be provided to the second ML model 125 to identify a semantically similar node. For example, the second ML model 125 may comprise a large language model, in which case the ML model interface 124 may generate one or more prompts that provide the first document format 310 and the second document format 320 and the prompts may further indicate that a given set of nodes could not be matched, so the second ML model 125 should attempt to match at least for example the node 312D. As noted, the second ML model comprised as an LLM may determine a match that is semantically similar to the node 312D (with a tag text string of “RmtLctnMtd”).

At 235, the process 200 may include receiving, from the second machine learning model, a fourth set of nodes matching the third set of nodes of the first document format. Referring to the prior example where the node 312D (with a tag text string of “RmtLctnMtd”) is provided to the LLM), the ML model interface 124 may receive from the second ML model comprised as an LLM a semantically similar node to the node 312D. For example, the second ML model may return node 322D (with a tag text string of “RmtLctnDtls”). In some implementations, the returned semantic match, such as node 322D (with a tag text string of “RmtLctnDtls”) is presented at a user interface at a client device for confirmation as correct. If the second ML model cannot find a match in the target node, the second ML model may respond, no semantically similar matches, in which case the node 312D may be added as a “new” node in the target format, such as the second document format 320.

At 240, the process 200 may include performing a first mapping between the first set of nodes and the second set of nodes and further performing a second mapping between the third set of nodes and the fourth set of nodes. The data formatter 1200 may then map the similar nodes identified by the first ML model 122 and the second ML model 125. For example, the first set of nodes (e.g., node 312A and node 312B) may be mapped to the second document format 320 (e.g., including node 322A and node 322B), and any the matches provided by the second ML model 125 may also be mapped (e.g., the node 312D mapped to the node 322D). Any new nodes may be added as well.

At 245, the process 200 may include converting, based on the first mapping and the second mapping, the first document format and the second document format. When the matching nodes are mapped at 240, the data formatter 1200 may merge the source (e.g., the first document format 310) and the target document format (e.g., the second document format 320) to form a merged (or converted) document format. This merged document format may thus include the customizations of the first document format 310 and for examples changes caused by an updated standard, such as a revision or version changed. The merged document format may be stored (e.g., under the mapping name at the third selection 306) in persistent store, such as via the database instance 114C.

At 250, the process 200 may include accessing the merged or converted second document format to enable formatting a document in the converted second document format. When an application at the cloud platform 110 exchanges a document (e.g., payment document) in the new format, the application 112X may retrieve the merged document format (e.g., stored under the mapping name (see, e.g., the third selection 306) at the database instance 114C) and sends to the second party system a document formatted using the converted document format.

As noted above with respect to 225-230, when the data formatter 1200 (or the first ML model 122) cannot successfully map all of the nodes from the first document format to the second document format, the second ML model 125 (which as noted may comprise an LLM) may be used. When this is the case, the ML model interface may, as part of the prompts toward the second ML model 125, provide context include (1) a name of the node in the first document format that could not be mapped at 225 and (2) a structure of the target document format (e.g., the second document format 320) including any nodes in the second document format that have yet to be mapped and therefore might semantically equivalent to the node in the source first document format. For example, the second ML model 125, such as an LLM, may be prompted at 230 to find a correct node in the target document format based on a similarity of the name (e.g. a node called “LctnPstlAdr” from source document format would be semantically equivalent to “LctnPstlAdr” or “PstlAdr” in the target document format). The prompt (or, e.g., request) to the second ML model 125 may be via the ML model interface 124, which may be configured to not only access the second ML model, such as the LLM, but also configured to access the source and target document formats including their nodes (e.g., by accessing a database instance, such as database instance 114C).

To illustrate by way of an example, the source target document format (e.g., first document format 310) may be a customized format persisted using the cloud platform 110. This customized format may be in accordance with for example ISO20022 pain.001.001.03. The target format (e.g., the second document format 320) may be correspond to ISO20022 pain.001.001.09, for example. This second document format 320 may be required by the second party system for submitting electronic payments to a bank or other type of financial institution or intermediary. The use of the first ML model 122 and the second ML model 125 (which may comprise an LLM) may be used to perform the document format change.

With respect to the first ML model 122, the data formatter 1200 may use a matching algorithm of node names between the source document format (e.g., the first document format 310) and the target document format (e.g., the second document format 320). But the first ML model 122 and/or the matching algorithm may, as noted above, find a match for certain nodes (which are in the first document format 310) in the nodes of the target format, such as the second document format 320.

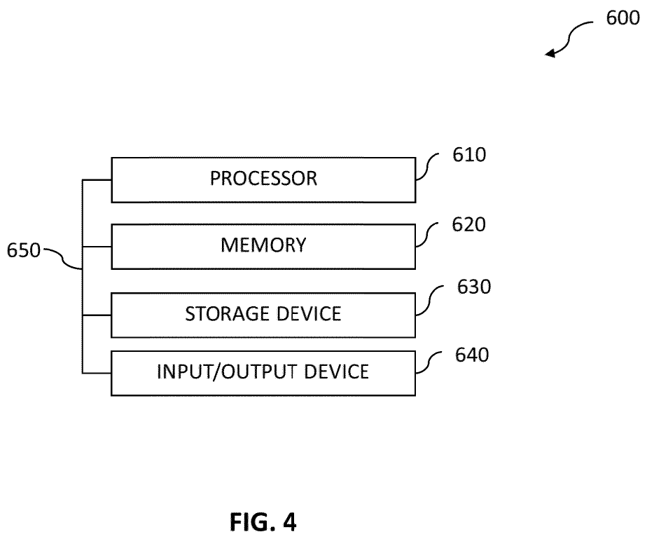

In some implementations, the current subject matter may be configured to be implemented in a system 600, as shown in FIG. 4. The system 600 may include a processor 610, a memory 620, a storage device 630, and an input/output device 640. Each of these components may be interconnected using a system bus 650. The processor 610 may be configured to process instructions for execution within the system 600. In some implementations, the processor 610 may be a single-threaded processor. In alternate implementations, the processor 610 may be a multi-threaded processor. The processor 610 may be further configured to process instructions stored in the memory 620 or on the storage device 630, including receiving or sending information through the input/output device 640. The processor 610 may be further configured to execute the processes described with reference to FIG. 2. The memory 620 may store information within the system 600. In some implementations, the memory 620 may be a computer-readable medium. In alternate implementations, the memory 620 may be a volatile memory unit. In yet some implementations, the memory 620 may be a non-volatile memory unit. The storage device 630 may be capable of providing mass storage for the system 600. In some implementations, the storage device 630 may be a computer-readable medium. In alternate implementations, the storage device 630 may be a floppy disk device, a hard disk device, an optical disk device, a tape device, non-volatile solid-state memory, or any other type of storage device. The input/output device 640 may be configured to provide input/output operations for the system 600. In some implementations, the input/output device 640 may include a keyboard and/or pointing device. In alternate implementations, the input/output device 640 may include a display unit for displaying graphical user interfaces.

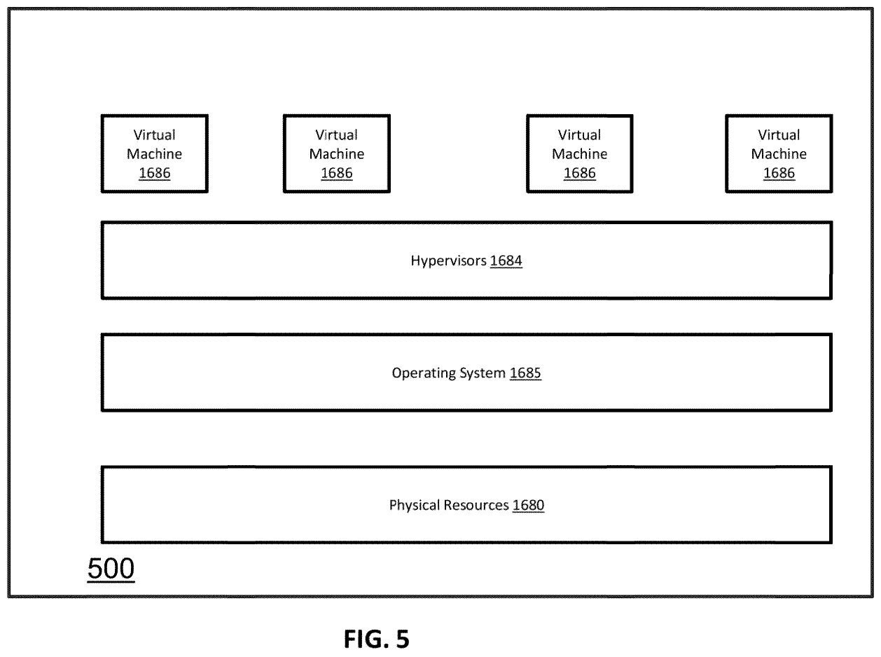

FIG. 5 depicts an example implementation of the system 500. The system 500 may comprise one or more of the components of FIG. 1 and used to provide one or more aspects of the process 200. The system 500 may be implemented using various physical resources 1680, such as at least one or more hardware servers, at least one storage, at least one memory, at least one network interface, and the like. The system may also be implemented using infrastructure, as noted above, which may include an operating system 1685 for the physical resources 1680 and at least one hypervisor 1684 (which may create and run at least one virtual machine 1686). For example, each multitenant application (e.g., application 112X) may be run on a corresponding virtual machine 1686.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random-access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1: A computer-implemented method comprising:
receiving an indication of a change for a first document type, the change from a first document format to a second document format;
retrieving the first document format comprising a first plurality of nodes in a first hierarchal structure and the second document format comprising a second plurality of nodes in a second hierarchal structure;
detecting differences in the first document format and the second document format, wherein the detecting the differences comprises:
   comparing, using a first machine learning model, the first document format and the second document format, the first machine learning model matching a first set of nodes in the first document format to a second set of nodes in the second document format,
   in response to a third set of nodes of the first document format detected as not having a match in the second plurality of nodes of the second document format, providing, to a second machine learning model, the second document format and the third set of nodes of the first document format, and
   receiving, from the second machine learning model, a fourth set of nodes matching the third set of nodes of the first document format;
performing a first mapping between the first set of nodes and the second set of nodes and further performing a second mapping between the third set of nodes and the fourth set of nodes;
converting, based on the first mapping and the second mapping, the first document format and the second document format; and
accessing the converted second document format to enable formatting a document in the converted second document format.
Example 2: The computer-implemented method of Example 1, wherein the first document type comprises a payment document.
Example 3: The computer-implemented method of any of Examples 1-2, wherein the first document format comprises a first extensible markup language document including the first plurality of nodes in the first hierarchal structure, and wherein the second document format comprises a second extensible markup language document comprising the second plurality of nodes in the second hierarchal structure.
Example 4: The computer-implemented method of any of Examples 1-3, wherein the first machine learning model compares the first document format and the second document format by matching a first set of tags for the first set of nodes to a second set of tags for the second set of nodes, wherein the matching is based on a same text string between tags.
Example 5: The computer-implemented method of any of Examples 1-4, wherein the third set of nodes correspond to a third set of tags in the first document format, wherein the third set of tags do not have a corresponding match based on a same text string between tags.
Example 6: The computer-implemented method of any of Examples 1-5, wherein the second machine learning model is a large language model, wherein the large language model matches the fourth set of nodes matching to the third set of nodes of the first document format using a similarity in text strings between tags.
Example 7: A system comprising:
at least one processor; and
at least one memory including instructions which when executed by the at least one processor causes operations comprising:
   receiving an indication of a change for a first document type, the change from a first document format to a second document format;
   retrieving the first document format comprising a first plurality of nodes in a first hierarchal structure and the second document format comprising a second plurality of nodes in a second hierarchal structure;
   detecting differences in the first document format and the second document format, wherein the detecting the differences comprises:
      comparing, using a first machine learning model, the first document format and the second document format, the first machine learning model matching a first set of nodes in the first document format to a second set of nodes in the second document format,
      in response to a third set of nodes of the first document format detected as not having a match in the second plurality of nodes of the second document format, providing, to a second machine learning model, the second document format and the third set of nodes of the first document format, and
      receiving, from the second machine learning model, a fourth set of nodes matching the third set of nodes of the first document format;
      performing a first mapping between the first set of nodes and the second set of nodes and further performing a second mapping between the third set of nodes and the fourth set of nodes;
      converting, based on the first mapping and the second mapping, the first document format and the second document format; and
      accessing the converted second document format to enable formatting a document in the converted second document format.
Example 8: The system of Example 7, wherein the first document type comprises a payment document.
Example 9: The system of any of Examples 7-8, wherein the first document format comprises a first extensible markup language document including the first plurality of nodes in the first hierarchal structure, and wherein the second document format comprises a second extensible markup language document comprising the second plurality of nodes in the second hierarchal structure.
Example 10: The system of any of Examples 7-9, wherein the first machine learning model compares the first document format and the second document format by matching a first set of tags for the first set of nodes to a second set of tags for the second set of nodes, wherein the matching is based on a same text string between tags.
Example 11: The system of any of Examples 7-10, wherein the third set of nodes correspond to a third set of tags in the first document format, wherein the third set of tags do not have a corresponding match based on a same text string between tags.
Example 12: The system of any of Examples 7-11, wherein the second machine learning model is a large language model, wherein the large language model matches the fourth set of nodes matching to the third set of nodes of the first document format using a similarity in text strings between tags.
Example 13: A non-transitory computer-readable storage medium including instructions which when executed by at least one processor causes operations comprising:
receiving an indication of a change for a first document type, the change from a first document format to a second document format;
retrieving the first document format comprising a first plurality of nodes in a first hierarchal structure and the second document format comprising a second plurality of nodes in a second hierarchal structure;
detecting differences in the first document format and the second document format, wherein the detecting the differences comprises:
   comparing, using a first machine learning model, the first document format and the second document format, the first machine learning model matching a first set of nodes in the first document format to a second set of nodes in the second document format,
   in response to a third set of nodes of the first document format detected as not having a match in the second plurality of nodes of the second document format, providing, to a second machine learning model, the second document format and the third set of nodes of the first document format, and
   receiving, from the second machine learning model, a fourth set of nodes matching the third set of nodes of the first document format;
   performing a first mapping between the first set of nodes and the second set of nodes and further performing a second mapping between the third set of nodes and the fourth set of nodes;
   converting, based on the first mapping and the second mapping, the first document format and the second document format; and
   accessing the converted second document format to enable formatting a document in the converted second document format.
Example 14: The non-transitory computer-readable storage medium of Example 13, wherein the first document type comprises a payment document.
Example 15: The non-transitory computer-readable storage medium of any of Examples 13-14, wherein the first document format comprises a first extensible markup language document including the first plurality of nodes in the first hierarchal structure, and wherein the second document format comprises a second extensible markup language document comprising the second plurality of nodes in the second hierarchal structure.
Example 16: The non-transitory computer-readable storage medium of any of Examples 13-15, wherein the first machine learning model compares the first document format and the second document format by matching a first set of tags for the first set of nodes to a second set of tags for the second set of nodes, wherein the matching is based on a same text string between tags.
Example 17: The non-transitory computer-readable storage medium of any of Examples 13-16, wherein the third set of nodes correspond to a third set of tags in the first document format, wherein the third set of tags do not have a corresponding match based on a same text string between tags.
Example 18: The non-transitory computer-readable storage medium of any of Examples 13-16, wherein the second machine learning model is a large language model, wherein the large language model matches the fourth set of nodes matching to the third set of nodes of the first document format using a similarity in text strings between tags.

The implementations set forth in the foregoing description do not represent all implementations consistent with the subject matter described herein. Instead, they are merely examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method comprising:
receiving an indication of a change for a first document type, the change from a first document format to a second document format;
retrieving the first document format comprising a first plurality of nodes in a first hierarchal structure and the second document format comprising a second plurality of nodes in a second hierarchal structure;
detecting differences in the first document format and the second document format, wherein the detecting the differences comprises:
comparing, using a first machine learning model, the first document format and the second document format, the first machine learning model matching a first set of nodes in the first document format to a second set of nodes in the second document format,
in response to a third set of nodes of the first document format detected as not having a match in the second plurality of nodes of the second document format, providing, to a second machine learning model, the second document format and the third set of nodes of the first document format, and
receiving, from the second machine learning model, a fourth set of nodes matching the third set of nodes of the first document format;
performing a first mapping between the first set of nodes and the second set of nodes and further performing a second mapping between the third set of nodes and the fourth set of nodes;
converting, based on the first mapping and the second mapping, the first document format and the second document format; and
accessing the converted second document format to enable formatting a document in the converted second document format.

2. The computer-implemented method of claim 1, wherein the first document type comprises a payment document.

3. The computer-implemented method of claim 1, wherein the first document format comprises a first extensible markup language document including the first plurality of nodes in the first hierarchal structure, and wherein the second document format comprises a second extensible markup language document comprising the second plurality of nodes in the second hierarchal structure.

4. The computer-implemented method of claim 1, wherein the first machine learning model compares the first document format and the second document format by matching a first set of tags for the first set of nodes to a second set of tags for the second set of nodes, wherein the matching is based on a same text string between tags.

5. The computer-implemented method of claim 1, wherein the third set of nodes correspond to a third set of tags in the first document format, wherein the third set of tags do not have a corresponding match based on a same text string between tags.

6. The computer-implemented method of claim 1, wherein the second machine learning model is a large language model, wherein the large language model matches the fourth set of nodes matching to the third set of nodes of the first document format using a similarity in text strings between tags.

7. A system comprising:
at least one processor; and
at least one memory including instructions which when executed by the at least one processor causes operations comprising:
receiving an indication of a change for a first document type, the change from a first document format to a second document format;
retrieving the first document format comprising a first plurality of nodes in a first hierarchal structure and the second document format comprising a second plurality of nodes in a second hierarchal structure;
detecting differences in the first document format and the second document format, wherein the detecting the differences comprises:
comparing, using a first machine learning model, the first document format and the second document format, the first machine learning model matching a first set of nodes in the first document format to a second set of nodes in the second document format,
in response to a third set of nodes of the first document format detected as not having a match in the second plurality of nodes of the second document format, providing, to a second machine learning model, the second document format and the third set of nodes of the first document format, and
receiving, from the second machine learning model, a fourth set of nodes matching the third set of nodes of the first document format;
performing a first mapping between the first set of nodes and the second set of nodes and further performing a second mapping between the third set of nodes and the fourth set of nodes;
converting, based on the first mapping and the second mapping, the first document format and the second document format; and
accessing the converted second document format to enable formatting a document in the converted second document format.

8. The system of claim 7, wherein the first document type comprises a payment document.

9. The system of claim 7, wherein the first document format comprises a first extensible markup language document including the first plurality of nodes in the first hierarchal structure, and wherein the second document format comprises a second extensible markup language document comprising the second plurality of nodes in the second hierarchal structure.

10. The system of claim 7, wherein the first machine learning model compares the first document format and the second document format by matching a first set of tags for the first set of nodes to a second set of tags for the second set of nodes, wherein the matching is based on a same text string between tags.

11. The system of claim 7, wherein the third set of nodes correspond to a third set of tags in the first document format, wherein the third set of tags do not have a corresponding match based on a same text string between tags.

12. The system of claim 7, wherein the second machine learning model is a large language model, wherein the large language model matches the fourth set of nodes matching to the third set of nodes of the first document format using a similarity in text strings between tags.

13. A non-transitory computer-readable storage medium including instructions which when executed by at least one processor causes operations comprising:
receiving an indication of a change for a first document type, the change from a first document format to a second document format;
retrieving the first document format comprising a first plurality of nodes in a first hierarchal structure and the second document format comprising a second plurality of nodes in a second hierarchal structure;
detecting differences in the first document format and the second document format, wherein the detecting the differences comprises:
comparing, using a first machine learning model, the first document format and the second document format, the first machine learning model matching a first set of nodes in the first document format to a second set of nodes in the second document format,
in response to a third set of nodes of the first document format detected as not having a match in the second plurality of nodes of the second document format, providing, to a second machine learning model, the second document format and the third set of nodes of the first document format, and
receiving, from the second machine learning model, a fourth set of nodes matching the third set of nodes of the first document format;
performing a first mapping between the first set of nodes and the second set of nodes and further performing a second mapping between the third set of nodes and the fourth set of nodes;
converting, based on the first mapping and the second mapping, the first document format and the second document format; and
accessing the converted second document format to enable formatting a document in the converted second document format.

14. The non-transitory computer-readable storage medium of claim 13, wherein the first document type comprises a payment document.

15. The non-transitory computer-readable storage medium of claim 13, wherein the first document format comprises a first extensible markup language document including the first plurality of nodes in the first hierarchal structure, and wherein the second document format comprises a second extensible markup language document comprising the second plurality of nodes in the second hierarchal structure.

16. The non-transitory computer-readable storage medium of claim 13, wherein the first machine learning model compares the first document format and the second document format by matching a first set of tags for the first set of nodes to a second set of tags for the second set of nodes, wherein the matching is based on a same text string between tags.

17. The non-transitory computer-readable storage medium of claim 13, wherein the third set of nodes correspond to a third set of tags in the first document format, wherein the third set of tags do not have a corresponding match based on a same text string between tags.

18. The non-transitory computer-readable storage medium of claim 13, wherein the second machine learning model is a large language model, wherein the large language model matches the fourth set of nodes matching to the third set of nodes of the first document format using a similarity in text strings between tags.
